(19) United States
(12) Patent Application Publication
(10) Pub. No.: US 2025/0093249 A1
(43) Pub. Date: Mar. 20, 2025

(54) PHOTOACOUSTIC SPECTROMETER FOR REAL-TIME DUST MONITORING

(71) Applicant: BOARD OF REGENTS OF THE NEVADA SYSTEM OF HIGHER EDUCATION, ON BEHALF OF THE UNIV. OF NEVADA, Reno, NE (US)

(72) Inventors: W. Patrick Arnott, Reno, NV (US); Samuel Joe Taylor, Reno, NV (US); Pedro Nascimento, Reno, NV (US); Karoly Kocsis, Reno, NV (US)

(73) Assignee: Board of Regents of the Nevada System of Higher Education, on Behalf of the University of Nevada, Re, Reno, NV (US)

(21) Appl. No.: 18/291,502

(22) PCT Filed: Jul. 22, 2022
(86) PCT No.: PCT/US2022/038088

§ 371 Date: Jan. 23, 2024

Related U.S. Application Data
(60) Provisional application No. 63/298,120, filed on Jan. 10, 2022.
(60) Provisional application No. 63/225,304, filed on Jul. 23, 2021.

(51) Int. Cl. G01N 15/075

(52) U.S. Cl. CPC G01N 15/075

(57) ABSTRACT

Methods and devices for determining a mass concentration of an airborne or respirable species in real time are provided. Methods can include drawing in a particulate species through an inlet and into a chamber of a resonator of a monitoring device and directing a laser beam into the chamber of the resonator and toward the particulate species such that the particulate species absorbs energy from the laser beam and transmits heat to the surrounding air within the chamber of the resonator. A power of the laser beam as it leaves the resonator and a sound pressure within the chamber of the resonator can be determined. Determining a mass concentration of the particulate species based on a ratio of the measured sound pressure and power of the laser beam, and whether the mass concentration of the particulate species exceeds a threshold concentration can be achieved.

### CROSS REFERENCE TO RELATED APPLICATION

This application claims the benefit of U.S. Provisional Patent Application No. 63/298,120, filed Jan. 10, 2022, and U.S. Provisional Patent Application No. 63/225,304, filed Jul. 23, 2021. The prior applications are incorporated herein in their entirety.

### ACKNOWLEDGMENT OF GOVERNMENT SUPPORT

This invention was made with government support under grant 75D30119C06204 awarded by the National Institute for Occupational Safety and Health.

### FIELD

The present disclosure relates to monitoring particulate matter, and more particularly, monitoring the mass concentration of airborne particulates.

### BACKGROUND

Aerosols including harmful particulates such as respirable crystalline silica and coal dust pose significant health risks to those employed in occupations where exposure can occur, such as in the mining industry. These fine particulates within the respirable dust range can penetrate deep into the lungs, causing harmful damage to the lungs of those exposed. Long-term exposure to respirable dust produced in mining operations, for example, can cause a variety of lung diseases, such as pneumoconiosis, emphysema, and chronic obstructive pulmonary disease, otherwise known as black lung. Other risks include silicosis and lung cancer. Concentration levels of these harmful airborne particulates are monitored in an attempt to maintain concentration levels within safe and regulatory limits. Although numerous testing techniques and processes have been deployed, these techniques and processes have significant shortcomings, especially in the time it takes to collect a sample, process the data, and calculate the concentration levels. These conventional systems and methods can take several hours to multiple weeks to receive results for a single sample. Thus, improvements are needed.

### SUMMARY

Described herein are devices and methods for monitoring the mass concentration of airborne particulates within the surrounding environment. Specifically, the devices and methods of the present disclosure allow for monitoring in real time, the mass concentration of species of dust particles within an environment via photoacoustic spectrometry.

In one representative embodiment, a monitoring device can include a resonator having an inlet, an outlet, a chamber extending between the inlet and the outlet, and a resonant frequency, a pump mechanism configured to draw in and direct an airborne particulate surrounding the monitoring device into the inlet and through the chamber and outlet of the resonator, an optical source situated and configured to provide and direct a laser beam into the chamber of the resonator at a predetermined modulation frequency, wherein the airborne particulate within the resonator absorbs energy from the laser beam and transmits heat into the surrounding air, a photodetector situated and configured to receive and measure a power of the laser beam leaving the resonator, and a sensor situated and configured to measure a sound pressure within the chamber of the resonator associated with the heat transmitted from the airborne particulate.

In some embodiments, the monitoring device can also include a processor having computer-readable instructions, wherein by executing the instructions, the processor is configured to determine a mass concentration of the airborne particulate based on a ratio of the measured sound pressure of the resonator and power of the laser beam. In further embodiments, the processor can be further configured to determine whether the mass concentration of the airborne particulate exceeds a threshold concentration, and upon determining the mass concentration exceeds the threshold concentration, send an alert to one or more local and/or remote processors communicatively coupled to the processor of the monitoring device, wherein the alert indicates the mass concentration of the airborne particulate exceeds the threshold concentration. In still further embodiments, the processor can be further configured to communicate the mass concentration of the airborne particulate in real time to one or more local and/or remote processors communicatively coupled to the processor.

In some embodiments, the optical source can be a quantum cascade laser. In some embodiments, the resonant frequency of the resonator can range from 0 Hz to 2000 Hz. In some embodiments, a wavelength of the laser beam can range from 11 microns to 13 microns. In some embodiments, the predetermined modulation frequency of the laser beam can be equal to the resonant frequency of the resonator. In further embodiments, the laser beam can be modulated with a square wave at the predetermined modulation frequency.

In some embodiments, the monitoring device can include at least one acoustic filter situated and configured to filter sound external to the resonator chamber. In further embodiments, the photodetector can be a mercury-cadmium-telluride (MCT) detector. In still further embodiments, an amplifier can be coupled to the photodetector to amplify a signal output of the photodetector associated with the power of the laser beam. In some embodiments, the optical source can include one or more lasers. In some embodiments, the resonator can be a Helmholtz resonator or a cantilevered resonator. In some embodiments, the sensor is a microphone or a cantilever sensor.

In another embodiment, a method can include drawing in a particulate species through an inlet and into a chamber of a resonator of a monitoring device, directing a laser beam into the chamber of the resonator and toward the particulate species such that the particulate species absorbs energy from the laser beam and transmits heat to the surrounding air within the chamber of the resonator; measuring a power of the laser beam as it leaves the resonator and a sound pressure within the chamber of the resonator associated with the transmission of heat by the particulate species; and determining a mass concentration of the particulate species based on a ratio of the measured sound pressure and power of the laser beam.

In some embodiments, the method can further include modulating a power of the laser beam to correspond with a resonant frequency of the resonator. In some embodiments, the method can include determining whether the mass concentration of the particulate species exceeds a threshold concentration. In further embodiments, upon determining the mass concentration exceeds the threshold concentration, the method can further include sending an alert to one or more local and/or remote processors indicating the mass concentration of the particulate species exceeds the threshold concentration. In some embodiments, the alert can indicate a health risk to persons within a surrounding area of the monitoring device. In further embodiments, upon determining the mass concentration exceeds the threshold concentration, the method can further include triggering a local signal of the monitoring device to indicate the mass concentration of the particulate species exceeds the threshold concentration.

In some embodiments, the resonant frequency of the resonator can be within a range of 0 Hz to 2000 Hz. In other embodiments, the resonant frequency of the resonator can be within a range of 500 Hz or less.

In some embodiments, the method can further include filtering sound frequency external to the resonator. In some embodiments, the particulate species can include silica, kaolinite, coal dust, calcite, or a combination thereof. In some embodiments, the particulate species can include any particulate which absorbs light at the laser wavelength.

In some embodiments, the method can further include determining a mass absorption efficiency of the particulate species, wherein determining the mass concentration of the particulate species is based, in part, on the mass absorption efficiency. In some embodiments, wherein in determining the mass concentration of the particulate species, an interference caused by light absorption of at least one interferent of the particulate species is accounted for and disregarded from the mass concentration determination. In some embodiments, a method can include repeating one or more methods described herein continuously over a first period of time.

In another representative embodiment, a device for monitoring a mass concentration of silica particulates can include a resonator comprising an inlet, an outlet, a chamber extending between the inlet and the outlet, and a resonant frequency, a pump mechanism configured to draw in and direct silica particulates surrounding the monitoring device into the inlet and through the chamber and outlet of the resonator, a quantum cascade laser situated and configured to provide and direct a laser beam modulated with a square wave into the chamber of the resonator at a laser power modulation frequency approximately equal to the resonant frequency of the resonator, wherein the silica particulates within the resonator absorbs energy from the laser beam and transmits heat into the surrounding air within the chamber of the resonator, a photodetector situated and configured to receive and measure a power of the laser beam leaving the resonator, and a sensor situated and configured to measure a sound pressure within the chamber of the resonator associated with the heat transmitted from the silica particulates, wherein a wavelength of the laser beam ranges from 11 microns to 13 microns.

The foregoing and other objects, features, and advantages of the disclosed technology will become more apparent from the following detailed description, which proceeds with reference to the accompanying figures.

### BRIEF DESCRIPTION OF THE DRAWINGS

This application proceeds with reference to the attached drawings, which include the following figures. At least some of the drawings are color drawings.

FIG. 1 is a schematic diagram of a photoacoustic device for monitoring the mass concentration of one or more airborne particulates.

FIG. 2 is a schematic diagram illustrating light absorption, scattering, and transmission by one or more particulates within the monitoring device of FIG. 1.

FIG. 3-5 are graphs showing the real and imaginary refractive indices for two particulates as a function of wavelength.

FIG. 6 is a graph showing light penetration depth as a function of wavelength for the two particulates of FIGS. 3-5.

FIG. 7 is a graph showing an average mass absorption efficiency and penetration depth as a function of light wavelength for the two particulates of FIG. 3-6.

FIG. 8 is list of candidate wavelengths for a laser beam of the monitoring device of FIGS. 1-2.

FIGS. 9-10 are graphs showing an average mass absorption efficiency and mass scattering efficiency as a function of particulate diameter for the two particulates of FIGS. 3-7.

FIG. 11 is a graph showing a mass absorption efficiency for three particulates and a light absorption coefficient for two gases, as a function of wavelength.

FIG. 12 is a graph showing an amplitude and phase of a photoacoustic signal response as a function of particulate diameter at two different frequencies.

FIGS. 13-14 are images of one implementation of the monitoring device of FIG. 1.

FIG. 15 is a schematic diagram of an amplifier circuit for the monitoring device of FIGS. 13-14.

FIG. 16 illustrates a representative method for monitoring the mass concentration of one or more airborne particulates.

FIG. 17 is a schematic diagram of a representative computing environment of the disclosed technology.

FIGS. 18A-18D are times series measurements of dispersed silica dust, kaolinite dust, and coal dust.

FIG. 19 is graph showing a FTIR spectra from the measurement time series of FIG. 18D and a measurement using the photoacoustic device of the disclosed technology.

### DETAILED DESCRIPTION

### Monitoring Device—Example 1

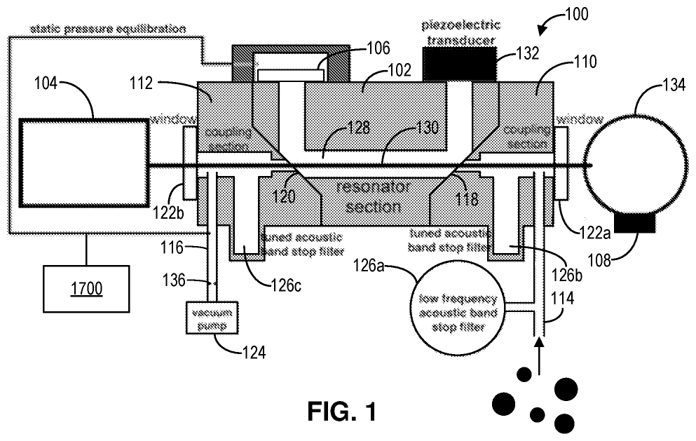

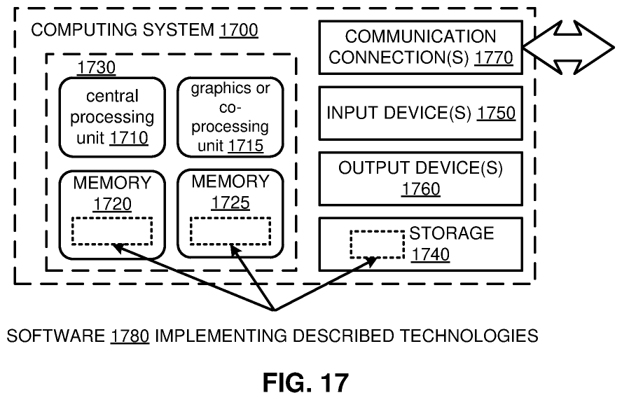

A schematic diagram of a representative photoacoustic device 100 for monitoring the mass concentration of one or more airborne particulates is shown in FIG. 1. As shown in FIG. 1, the monitoring device 100 can comprise an acoustic resonator 102, an optical source 104, a sensor 106, and a photodetector 108. First and second coupling sections 110, 112 can also be included to couple and/or situate one or more components of the monitoring device 100. For instance, the first and second coupling sections 110, 112 can be used to couple the optical source 104 and photodetector 108 to the resonator 102 and form a device inlet 114 and outlet 116. The device inlet and outlet 114, 116 can be coupled to an inlet 118 and outlet 120 of the resonator 102, respectively. The first and second coupling sections 110, 112 can also be used to situate one or more device windows 122a-122b, pump mechanisms 124 (e.g., a vacuum pump), and/or acoustic filters 126a-126c (e.g., stop-band filters) within the monitoring device 100. In representative examples, one or more components of the monitoring device 100 can be communicatively coupled (e.g., directly, a network, etc.) to a computing environment 1700 (FIG. 17) for operating the devices and implementing the methods described herein.

As shown in FIG. 1, the acoustic resonator 102 can comprise a chamber 128 extending between the first and second coupling sections 110, 112, forming a principal pathway for particulate matter to travel through the monitoring device 100. For instance, a pump mechanism 124 can be configured to create a vacuum which draws in aerosols from the surrounding environment through the device inlet 114 and directs the particulate matter thereof through the chamber 128 of the resonator 102 and to the device outlet 116. As the particulate matter is directed to the device outlet 116, for example, the particular matter can be captured via an aerosol filter within an outlet portion 136 of the monitoring device 100. The outlet portion 136 can also include and/or operate as a critical orifice for suppressing noise of the pump mechanism 124 and/or for setting the flow rate of the monitoring device 100. In some examples, the pump mechanism 124 can be configured to continuously drawn in aerosols during monitoring, while, in other examples, the pump mechanism can be configured to draw in only a desired volume of an aerosols, such as per a specified sample time.

The resonator 102 can also have a resonant frequency. The resonant frequency of the resonator 102 can amplify sound of equal or near equal frequency within the chamber 128, while filtering sound outside of the resonant frequency. The sensor 106 can be coupled to and/or situated within the resonator 102 and configured to measure sound and sound pressure within the resonator chamber 128. The sensor 106, for instance, can be used to measure sound pressure within the resonator chamber 128 using phase-sensitive detection, e.g., via a lock-in amplifier, to extract sound signals which have the same or similar frequency as the resonant frequency, such as during monitoring. In some examples, the sensor 106 can be any suitable sensor configured to measure acoustic signals within the resonator, for example and without limitation, a microphone, such as a diaphragm or membrane microphone, a cantilever sensor (e.g., a micromachined silicon cantilever with an optical interferometer to record cantilever movement), or other like device.

The coupling sections 110, 112 can also comprise one or more acoustic filters 126a-126c, which are tuned to attenuate undesirable frequencies that can cause interference with the sound measurements within the chamber 128. For example, the acoustic filters 126a-126c can be band-stop filters to dampen or decrease noise created external to the device 100 and/or by other components of the monitoring device 100 during operation, such as the pump mechanism 124 and device inlet 114. In addition to, or in lieu of band-stop filters, the acoustic filters 126a-126c can also comprise one or more resonators in series and/or locally placed resonant devices to reduce interference.

In addition to the sensor 106, the monitoring device 100 can also include a sound source 132 (e.g., piezoelectric transducer) which can be used to calibrate the acoustic resonator 102 to ensure the desired resonant frequency is maintained. In some instances, the sensor 106 and sound source 132 can be used to measure a precise value of the resonant frequency, such as to establish an accurate value for the resonant frequency for determining the mass concentration of particulate matter as described herein. In further examples, calibration can be an automated process.

As shown in FIG. 1, the optical source 104 can be situated and configured to produce and direct a laser beam 130 into the chamber 128 of the resonator 102. The optical source 104, for instance, can be configured to supply and direct a laser beam of a specified power, modulation frequency, and one or more wavelengths within an electromagnetic spectrum. As illustrated, the laser beam 130 provided by the optical source 104 can be directed toward the particulate matter within the chamber 128 and through a pair of windows 122a, 122b situated at respective ends of the monitoring device 100 and openings formed by the coupling sections 110, 112. In representative examples, the windows 122a-122b can be formed of a material that provides relatively high transmittance of light at the operating wavelengths of the laser beam 130, such as within the long-infrared range. As an example, windows 122a-122b can be made of a potassium bromide or sodium chloride material due to their relatively high transmissivity. In other examples, the windows 122a-122b can be made from any variety of materials.

The photodetector 108 can be coupled to the resonator 102 and/or situated such that the photodetector 108 collects and measures the portion of the laser beam 130 transmitted through the resonator 102, i.e., the power of the laser beam 130. The photodetector 108 can, in some examples, be coupled to an integrating sphere 134 configured to intercept the laser beam 130 as it leaves the resonator chamber 128, to dilute the beam such that the beam is not directly focused on the photodetector 108 and cause unwanted damage and sensitivity to alignment. In some examples, the photodetector 108 can be a mercury-cadmium-telluride (MCT) detector that can collect and measure the power of the laser beam 130 as the light leaves the resonator chamber 128. In other examples, however, the photodetector can be any other suitable photodetector operable to collect and measure the power of the laser beam 130. The photodetector 108 can be, for example, a non-cooled detector and/or a thermoelectrically cooled detector.

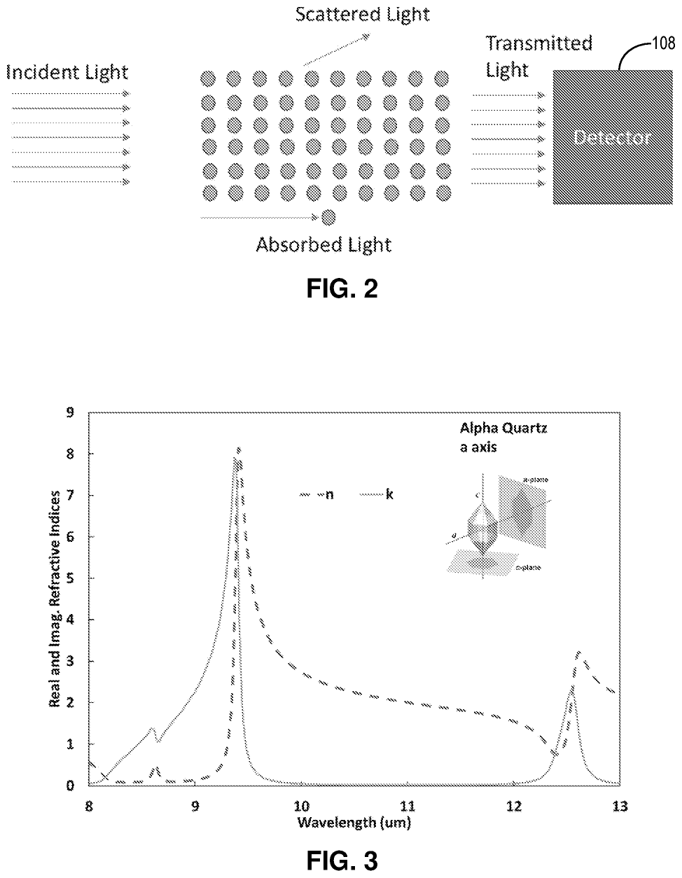

As illustrated in the schematic diagram of FIG. 2, as the laser beam 130 travels through resonator chamber 128, light incident on the particulates is either absorbed, transmitted to the photodetector 108 to be measured, or scattered. As light is absorbed by the particulates, the particulates convert the light into heat, which is diffused into the resonator chamber 128. This diffusion of heat into the resonator chamber 128 can be used to create a standing acoustic wave and measurable quantity for determining mass concentration of the particulate matter being monitored. For instance, in representative examples, the laser beam 130 of the monitoring device 100 can be modulated with a waveform at a predetermined modulation frequency (e.g., a square waveform via a waveform generator). Modulation of the laser beam 130 can also ensure the predetermined modulation frequency falls within a passband of the resonator 102 and at or close to the resonant frequency. The thermal expansion and contraction caused by the transmission of heat to the surrounding air by the particulates at this frequency, creates a standing wave with a frequency equal or near equal to the frequency of the modulated laser beam 130, thereby creating sound pressure within the chamber 128 of the resonator 102. The resulting sound pressure can be measured via the sensor 106. These values can be used to determine a light absorption coefficient for the particulate matter being monitored and consequently, the mass concentration of that particulate matter within the surrounding environment.

Accordingly, the predetermined frequency of the laser beam 130, i.e., the modulation frequency, can be set equal or near equal to the resonant frequency of the resonator 102, such as to facilitate greater accuracy in measurements due to the amplification effect provided by the resonator 102. In other instances, however, the laser beam can be modulated according to other waveforms and/or frequencies.

Using a photoacoustic equation, the measured sound pressure within the resonator chamber 128 and the power of the laser beam 130 can be related to a light absorption coefficient β_{abs} for a given particulate matter. The light absorption coefficient β_{abs} for particulate matter can be expressed by the following equation:

$${β}_{abs} = \frac{{P}_{m}}{{P}_{L}} \frac{{A}_{res}}{γ - 1} \frac{{π}^{2} {f}_{0}}{Q}$$

Where Pₘ is the sound pressure measured by the sensor 106, P_{L} is the power of the laser beam 130 as measured by the photodetector 108, f₀ is the resonant frequency of the resonator 102, and Q is the resonator quality factor, e.g., as measured by the sensor 106 and sound source 132. Aᵣₑₛ and γ can be constants and represent the cross-sectional area of the resonator 102 and the ratio of isobaric and isochoric specific heats for ambient air, respectively.

As mentioned above, as particulates within the chamber 128 of the resonator 102 absorb energy from the laser beam 130, which is modulated at a predetermined modulation frequency, the resulting thermal expansion and contraction within the chamber 128 creates a standing wave of the same or similar frequency as the modulated laser beam 130, creating the sound pressure measured above. Accordingly, it can be advantageous to have the optical source 104 emit the laser beam 130 at a wavelength strongly absorbed by the particulate matter being monitored and negligibly absorbed by the other species present within an aerosol sample in the resonator chamber 128. Light absorption which occurs throughout or nearly throughout the volume of the particulate matter being monitored, for instance, makes the absorption measurement sensitive to the total mass concentration of that particulate matter.

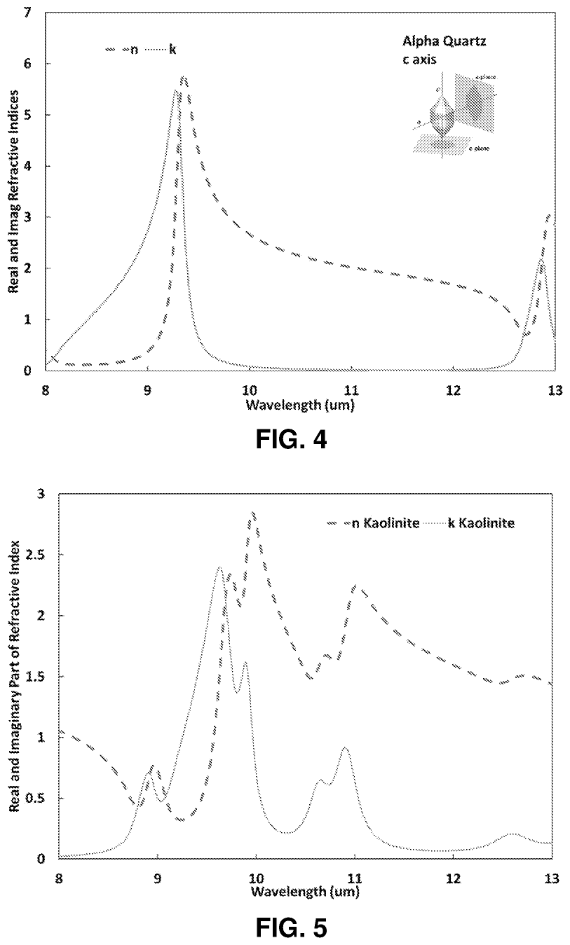

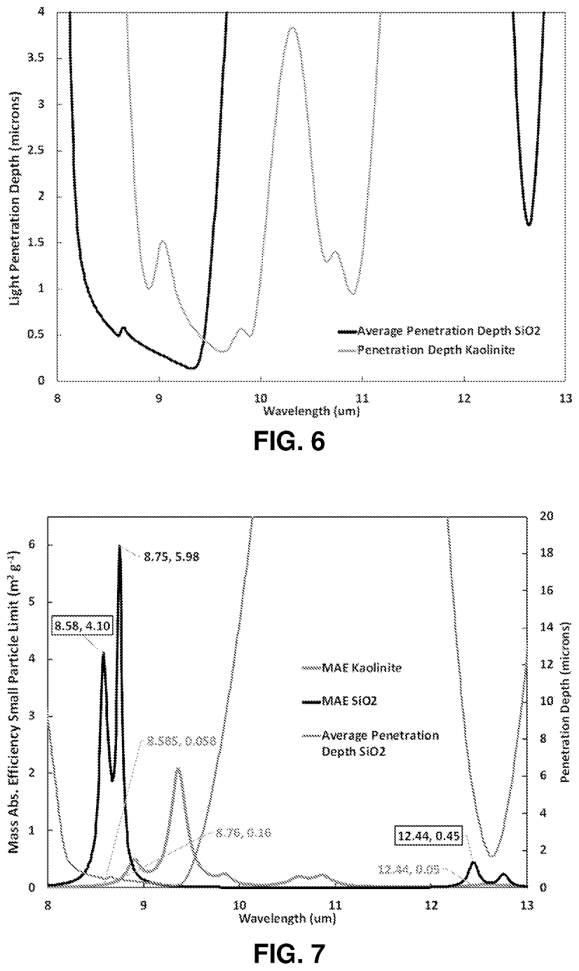

Generally, the limit for light absorption for a given particulate matter is reached when the diameter of the particulate matter is relatively lesser than the penetration depth of the laser beam 130. The light penetration depth (δ) is given by the expression:

$$δ = \frac{λ}{4 π k}$$

Where λ is the wavelength of the laser beam 130 and k is the imaginary part of the refractive index (e.g., given by m=n+ik). As demonstrated by the above expression for penetration depth δ, relatively greater values of the imaginary part of the refractive index results in relatively low penetration depths. As an example, FIGS. 3-5 show the real and imaginary refractive indices for alpha-quartz silica (FIGS. 3-4) and kaolinite (FIG. 5) as a function of wavelength for an incident light, with FIGS. 3 and 4 illustrating the real and imaginary parts of silica with polarization parallel to the “a” and “c” crystalline axes, respectively. FIG. 6 shows light penetration depth δ as a function of wavelength for both silica and kaolinite. As shown in FIGS. 3 and 4, a relatively greater value or peak of the imaginary part of the refractive index for silica occurs at a wavelength of approximately 9.2 microns. FIG. 5 shows that a relatively greater value or peak of the imaginary part of the refractive index for kaolinite occurs at a wavelength of approximately 9.7 microns. As shown in FIG. 6, the peaks for the imaginary parts of both silica and kaolinite correspond to a relatively low light penetration of less than one micron. By comparison, the light penetration for silica at a wavelength of approximately 12.8 microns is relatively greater, at over 1.5 microns.

The mass absorption efficiency (MAE), also referred to as the mass attenuation coefficient, can be used to characterize the penetration of the laser beam 130 into the volume of the particulate matter being monitored, which in the following description is silica and its potential interferent kaolinite. The MAE (m²/g) can be an approximation for those instances when the wavelength is larger than a diameter of the particulates being monitored, also referred to as the “small particle limit,” and can be expressed with the following equation:

$$M A E = \frac{6 π}{{p}_{p} λ} I M \{ \frac{{m}^{2} - 1}{{m}^{2} + 2} \}$$

Where ρₚ is the particulate matter density (e.g., 2.65 g/cm³ for silica and 2.6 g/cm³ for kaolinite), m is the complex refractive index (e.g., given by m=n+ik), and IM selects the imaginary part of the bracketed expression. The MAE depends on both the real and imaginary parts of the refractive index.

It should be appreciated that the MAE is a measure of the strength of the light absorption, while ρ is a measure of the mass concentration of the particular matter doing the light absorption. In the small particle limit, the light absorption coefficient β_{abs} can be expressed as:

$${β}_{abs} = M A E ρ$$

This expression relates the light absorption coefficient β_{abs}, which can be determined using the measured values of the laser beam 130 power and sound pressure above, to the MAE and the mass concentration ρ (also referred to as PM) of the particulate matter responsible for light absorption, such as silica here. In this way, the mass concentration for the particulate matter being monitored, can be expressed as:

$$ρ = {β}_{abs} / M A E$$

Where MAE can be determined theoretically or from empirical measurements. For example, the theoretical value of 0.45 m²/g can be used for silica when using a laser wavelength equal or approximately equal to 12.495 microns and/or the MAE can be calculated using data from another device or method, such as those described herein.

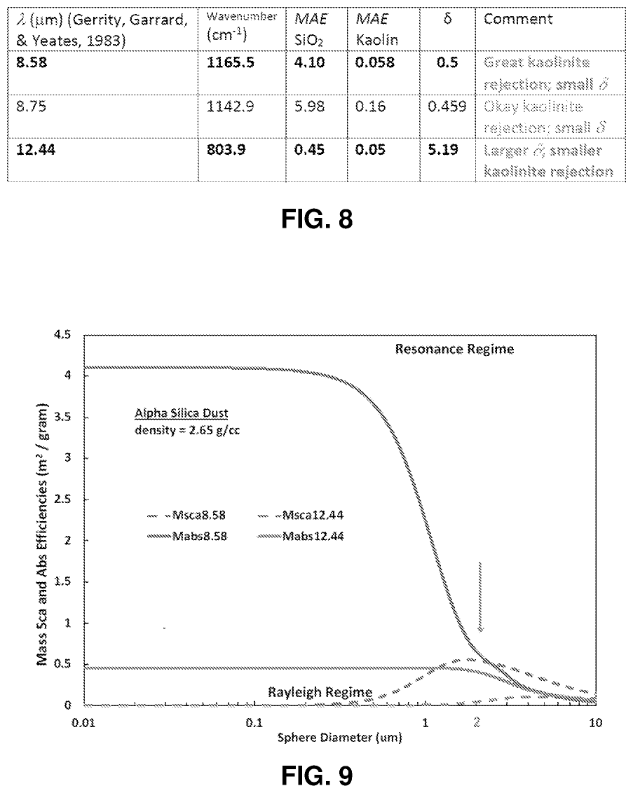

As shown in FIG. 7, by averaging the MAE for silica across both the “a” and “c” axes (i.e., MAE=⅓MAE_{c-axis}+⅔MAEₐ₋ₐₓᵢₛ) and kaolinite, and plotting both the average MAE and the penetration depth δ as a function of light wavelength, candidate wavelengths which provide a desirable degree of light absorption and penetration for mass concentration monitoring can be extracted. For example, the table of FIG. 8 lists the candidate wavelengths for the laser beam 130 extracted from FIG. 7. The candidate wavelengths (shown in bold), for instance, are chosen where the value for MAE and penetration depth δ are relatively large, as indicated in FIG. 7. Based on this list, λ=8.58 microns and λ=12.44 microns exhibit the greatest potential to provide both a desired penetration depth δ and absorption for monitoring silica, while also experiencing minimal interference from kaolinite.

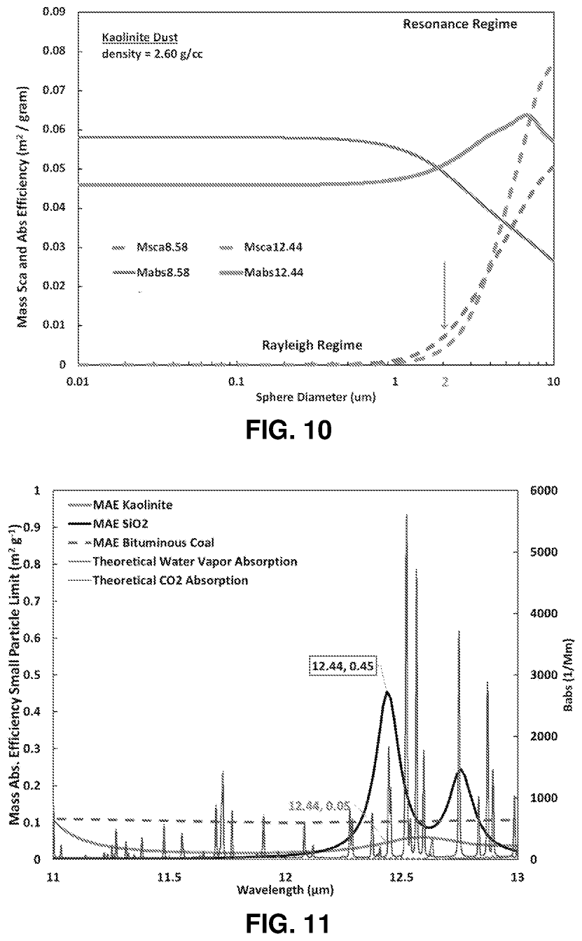

By modeling the MAE (also referred to as “M_{abs}”) and mass scattering efficiencies (MSE, also referred to as “M_{sca}”) of both silica and kaolinite at the candidate wavelengths determined above, a candidate wavelength which exhibits a desired light absorption and penetration can be selected for monitoring a particulate matter of interest via the monitoring device 100. For instance, FIGS. 9 and 10 show the average MAE and MSE (e.g., over crystal axes orientation calculated from Mie theory) for both silica and kaolinite as a function of particulate matter diameter, for the candidate wavelengths selected above: λ=8.58 microns and λ=12.44 microns. As illustrated in FIG. 9, the flat portions of the MAE curves for silica are associated with the wavelength range where light absorption per unit mass is independent of the particulate matter diameter, which can be desirable for determining its mass concentration. As indicated in FIG. 9, for example, the flatness of the MAE curve for the wavelength of 12.44 microns, ranges from 0 microns to approximately 2 microns, whereas the flatness of the curve for the wavelength of 8.58 microns, ranges from 0 microns to approximately 1 micron before declining. In comparison, the flatness of the MAE curve from kaolinite is relatively low for either wavelength. Accordingly, the candidate wavelength λ=12.44 microns can be relatively more desirable than the λ=8.58 microns, due to the former's moderate-to-strong light absorption and relatively larger light penetration depth δ.

Consequently, the optical source 104 of the monitoring device 100 can be any optical source which is configured to produce a desired wavelength determined to provide both a desired light absorption and penetration such as described above with respect to silica. In some examples, the optical source 104 can be a semiconductor laser, a gas laser, a solid-state laser, a fiber laser, a photonic crystal laser, and/or a free-electron laser.

In representative examples, the optical source 104 can be configured as a quantum cascade laser (QCL) which is tunable (i.e., can produce a range of wavelengths) to emit a laser within the mid-to-far infrared portion of the electromagnetic spectrum. QCLs, which achieve emission via quantum well heterostructures, are tunable to emit radiation within a given spectral range depending on the beam wavelength and power output. QCLs have also been shown to be useful for absorption spectroscopy. Configured in this way, the optical source 104 can emit a plurality of wavelengths within a desired spectral range, to provide spectra for one or more particulate matter within the chamber 128 as described herein.

In other representative examples, however, the optical source can be one or more single wavelength lasers. One or more lasers, for example, can be configured to emit a single wavelength. Each laser wavelength can correspond to a wavelength which has been determined to achieve a desired light absorption and penetration for monitoring the mass concentration of a specific particle within a dust sample. As one example, three lasers can each be configured to emit one of three respective wavelengths of 12.495 microns, 11.040 microns, and 11.826 microns. These values were determined to provide a desired light absorption and penetration for silica, kaolinite, and coal, respectively, using the same device and methods described herein. In such examples, one or more single wavelength lasers can be cost effective and/or provide higher power output than a single tunable laser, resulting in increased sensitivity.

FIG. 11 shows the small particle limit of the MAE for silica, kaolinite, and coal, and the light absorption coefficient β_{abs} for carbon dioxide, and water vapor, as a function of wavelength. The plot of FIG. 11, for example, illustrates the MAE for silica in the presence of other possible interferents beyond that of kaolinite, such as coal, carbon dioxide, and water vapor, as indicated by their respective MAE or light absorption coefficients β_{abs}. As evidenced by FIG. 11, both carbon dioxide and coal are relatively weak interferents. However, several peaks associated with water vapor appear proximate to the MAE peaks associated with silica. These peaks represent potentially strong interference by water vapor. As such, in some examples, a wavelength for the laser beam 130 can be chosen such that the corresponding MAE for the particulate of interest does not overlap with peaks associated with the water vapor interferent, but still proximate the desired laser wavelength. For instance, using the example of silica, a wavelength of 12.495 microns can be used. Similarly, this can be done for other interferents.

In some examples, the monitoring device 100 can include a humidity and air temperature sensor (not shown) such that the monitoring device 100 can be configured to quantify the water vapor concentration within the resonator 102. With this value known, for instance, a wavelength for the optical source 104 can be chosen to measure the light absorption coefficient of water vapor. With the mass absorption coefficient of water vapor calculated, the water vapor concentration can also be determined, as described above, which in turn can be used to calibrate the monitoring device 100 before monitoring a given particulate matter.

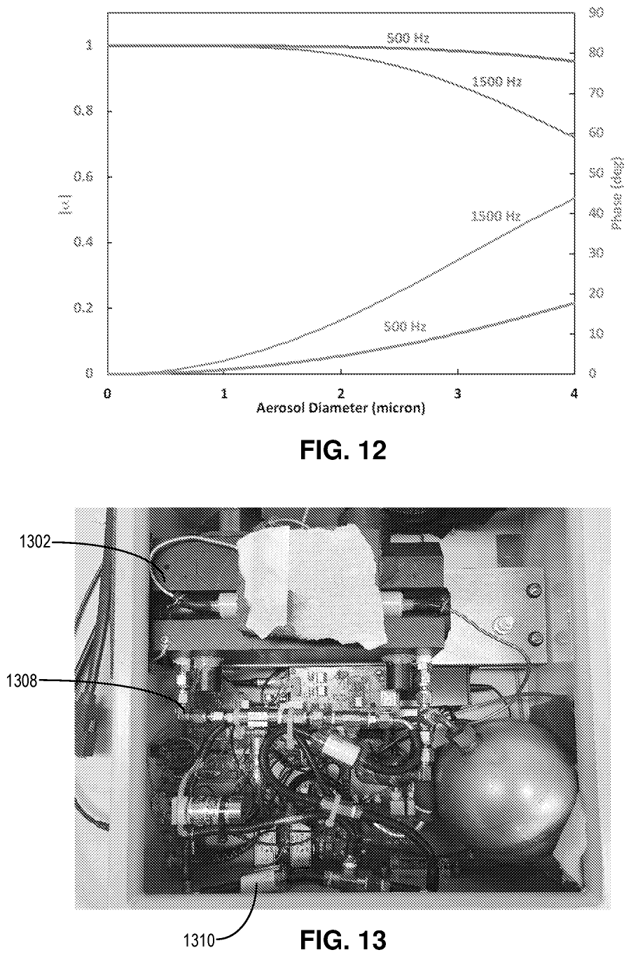

As shown in FIG. 12, the resonator 102 can also be configured, e.g., based on its size and geometry, to have a relatively low amplitude and relatively large phase response. For instance, FIG. 12 shows the amplitude (α) and phase (in degrees) of a photoacoustic signal response for the silica, as a function of particulate matter diameter at two different frequencies: 500 Hz and 1500 Hz. As demonstrated in FIG. 12, the 500 Hz resonator (e.g., a resonator having an operating resonant frequency ranging from 475 Hz to 525 Hz) has a relatively flat, or lesser sloped curved, in comparison to the curve for the 1500 Hz resonator (e.g., a resonator having an operating resonant frequency ranging from 1475 Hz to 1525 Hz). The difference between the two curves can be attributed to the heat which is released from the heated particulate matter during laser beam modulation, at the lower frequency. A lower frequency resonator can also be helpful to mitigate phase-lag.

Accordingly, in representative examples, the acoustic resonator 102 can be a Helmholtz resonator which operates within a desired resonant frequency. In some representative examples, for instance, the resonator 102 can be a Helmholtz resonator or another resonator operating within any desired range of frequencies from 0 Hz to 2000 Hz, exhibiting any desired amplitude and phase response, and/or have any range of dimensions to meet desired specifications, such as when a specific size and geometry of resonator may be desired for general space and/or weight optimization. In some further examples, the resonator 102 can have an operating resonance frequency of 500 Hz or less. In further examples, the resonator need not be a Helmholtz resonator, but can be any suitable resonator for use with the systems and methods described herein. In some examples, the resonator can be used in conjunction with cantilever photoacoustic technology, such as by employing a miniature cantilever and optical interferometry to record movement of the cantilever for determining a mass concentration.

### Monitoring Device—Example 2

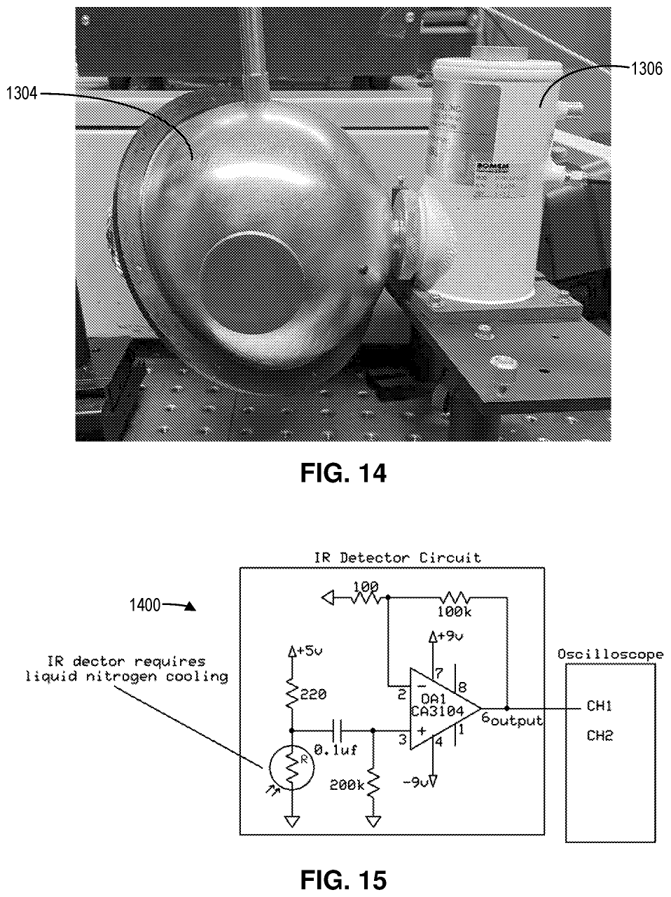

FIGS. 13-15 are images of a prototype photoacoustic monitoring device 1300 according to the disclosed technology. As shown in FIG. 13, the black component to the upper left is the resonator 1302 and corresponding resonator chamber, where the sensor measures the sound generated by the modulated laser beam interacting with the particulate matter within the resonator chamber. The optical source enters the chamber from the left via potassium bromide window attached to the resonator chamber. After passing through the chamber, the laser beam produced by the optical source exits on the right and through another potassium bromide window, where it is collected by the integrating sphere 1304 and measured by a mercury-cadmium-telluride (MCT) detector, which is contained within a small dewar 1306 containing liquid nitrogen (FIG. 14).

The purpose of the integrating sphere 1304 is to intercept and dilute the laser beam as it exits the resonator chamber such that the laser beam is not focused directly on the MCT detector. Due to the sensitivity of the MCT detector to infrared radiation, the detector is cooled by liquid nitrogen, which can be also reduce the effects of thermal noise created by the MCT detector.

FIG. 15 shows an amplifier circuit 1400 for the MCT detector to amplify the MCT signal, due to its relative weakness. For example, the signal from the MCT detector is received by the amplifier circuit 1400, and the resulting amplified signal output by the amplifier circuit 1400 is used by the monitoring device 1300 to measure the power output of the laser beam. In this instance, the MCT detector was approximately 80 Ohms when not illuminated. This resistance decreases as the detector receives infrared radiation via the laser beam. The MCT detector when coupled with the 220-Ohm resistor of the amplifier circuit 1400, which is coupled to a 5-Volt supply, creates a voltage divider. A 0.1 microfarad capacitor and the 200 kOhm resistor form a high-pass filter. In this configuration, the amplifier circuit 1400 functions as a noninverting amplifier. The laser power causes the resistance of the MCT detector to vary at approximately 10 milliOhms between when the laser is on and off.

FIG. 13 also shows the internal piping 1308 used to transport aerosol samples to and from the resonator chamber. Helmholtz resonators attached in series, dampen and decrease the noise produced by the pump mechanism and inlet system during operation to provide a clear sensor signal. Coupled to the piping 1308 via rubber tubing, are two blue, translucent cylinders 1310 which house white air filters. The air filters can be used to calibrate and zero the monitoring device 1300 periodically by switching air flow through the air filters, to ensure clean filtered air is measured. Although not shown, a relative humidity sensor also resides within the flow of the monitoring device 1300. These and all general functions of the monitoring device 1300, are controlled via a LabView program executed on a personal computer communicatively coupled to the monitoring device 1300.

Although the devices and techniques in the examples above are described with some particularity with respect silica and its interferents, it should be appreciated that the principles and techniques described herein can be applied to the monitoring of a broad range of particulate matter in a variety of contexts. For instance, any particulate matter which absorbs light at the laser wavelength employed can be monitored. It should also be appreciated that the devices need not have each component and/or the arrangement as described herein, but can have a variety of components and/or arrangements. Further details regarding monitoring devices can be found, for example, in U.S. Pat. Nos. 6,662,627 and 7,710,566, both of which are incorporated herein by reference in their entireties.

### Monitoring Airborne Particulates—Example

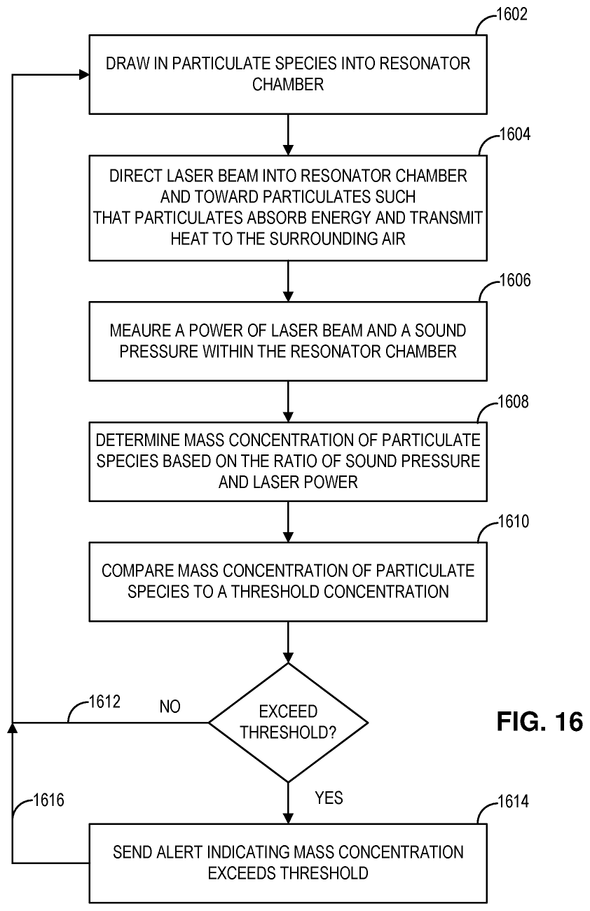

FIG. 16 is a method 1600 for monitoring the mass concentration of one or more airborne particulates using a monitoring device of the disclosed technology. At 1602, the method includes drawing in a particulate species within the surrounding environment of the device through an inlet and into a chamber of a resonator of the monitoring device. A pump mechanism of the monitoring device, such as a vacuum pump, can, for example, draw and direct the particulate species into and through the monitoring device. The particulate species can be respirable crystalline silica, otherwise known as silica dust, among other airborne particulates. In some instances, however, the particulate species can include silica, kaolinite, coal dust, water vapor, calcite, other particulates of interest, or any combination thereof.

At 1604, the method 1600 includes directing a laser beam provided by an optical source of the monitoring device into the chamber of the resonator and toward the silica particles within the resonator chamber such that the silica particles absorb energy from the laser beam and transmit heat to the surrounding air within the chamber of the resonator. Light incident on particles with the resonator chamber, for instance, is absorbed by the particles, scattered and free to interact with the other particles, or transmitted to a photodetector of the monitoring device. Via light absorption, light absorbed by the silica particles heats the silica particles, the heat of which is subsequently diffused into the surrounding air, i.e., the volume of the resonator chamber.

In some instances, the laser beam can be modulated with a square wave at a predetermined modulation frequency. In this way, the resulting thermal expansion and contraction caused by the transmission of heat by the silica particles as the particles are heated with the frequency of the modulated laser beam, creates a standing wave and sound pressure, i.e., a local pressure deviation from the ambient pressure within and/or surrounding the resonator. It is this sound pressure created within the resonator that can be a measurable quantity and related to the mass concentration of the silica particles within the surrounding environment. Accordingly, the predetermined modulation frequency of the laser beam can be the laser power modulation frequency of the laser beam set to the resonant frequency of the resonator to facilitate greater accuracy in measurements due to the amplification effect provided by the resonator. In other instances, the laser beam can be modulated according to other waveforms and/or other frequencies.

A wavelength of the laser beam can also be selected such that the laser beam is strongly absorbed by the silica particles and negligibly absorbed by the other species present within in the resonator, such as kaolinite, coal dust, and water vapor. In this manner, light absorption can occur throughout or nearly throughout the volume of each silica particle as to make the absorption measurement sensitive to the total mass concentration of silica per unit volume of the overall dust sample within the resonator. As such, the wavelength of the optical source, for instance, can be chosen such that there is moderate to strong light absorption and light penetration of the beam's radiation into the silica particles. The optical source, therefore, can be any optical source which is configured to produce a desired wavelength determined to provide both a desired light absorption and penetration for the particulate of interest, such as silica.

In some instances, the optical source can be any optical source which can provide light emission within the mid- to far-range IR spectra. One such source, can be a quantum cascade laser, while another source can be one or more single wavelength lasers. Accordingly, the laser beam can have a wavelength ranging from, in some examples, 11 microns to 13 microns when monitoring silica particles, and in specific examples, from 12.40 microns to 12.50 microns. However, different wavelengths can be utilized when monitoring other particles, such as kaolinite, coal dust, etc.

The method 1600 at 1606 includes measuring a power of the laser beam and a sound pressure within the resonator chamber associated with the transmission of heat into the surrounding air by the silica particles. The power of the laser beam can be measured by a photodetector of the monitoring device, for instance, as light from the laser beam is transmitted through and leaves the chamber of the resonator.

As mentioned, as the silica particles are heated via a laser beam modulated at the resonant frequency, the resulting thermal expansion and contraction creates a standing wave and sound pressure within the resonator chamber. A sensor coupled to and/or situated in relation to the resonator can measure the sound pressure. The sensor, for instance, can be used to measure the sound pressure using phase-sensitive detection to reliably extract the sound signals associated with the sound pressure.

Using the measured values for the power of the laser beam and the sound pressure, at 1608, the method 1600 includes determining a mass concentration of silica based on the ratio of the sound pressure and power of the laser beam. As described herein, the power of the laser beam (P_{L}) and sound pressure (Pₘ) can be related to the light absorption coefficient (β_{abs}) of silica, or other specific particulate of interest. The coefficient β_{abs} can then be divided by the mass absorption efficiency (MAE) of the particulate, to yield the mass concentration (ρ) of silica. The MAE can be selected where the MAE and light penetration of the of the light are relatively large and the interference of other particles, such as kaolinite, is relatively small.

Once determined, at 1610, the mass concentration of the particulate of interest, i.e., silica, can be compared to a threshold concentration. The threshold concentration can be a predetermined mass concentration of the particulate of interest which has been deemed undesirable. As an example, a threshold concentration of silica determined to be unsafe to workers, e.g., 50 μg/m³, can be compared to the mass concentration calculated using the monitoring device. The comparison between the calculated mass concentration and the threshold concentration can then, reveal whether an unsafe concentration of that given particulate is present within the surrounding environment. For instance, if the calculated mass concentration is equal to or greater than the threshold value (e.g., 50 μg/m³).

If upon determining the mass concentration of the particulate species is below the threshold concentration, at 1612, the method 1600 can reinitiate and begin another monitoring cycle (e.g., at 1602). Alternatively, if upon determining the mass concentration exceeds the threshold concentration, the method 1600 at 1614 can include sending an alert to one or more local and/or remote processors indicating the mass concentration of the airborne particulate exceeds the threshold concentration. A local processor, for example, can be a processor at the same site as the monitoring device, while a remote processor can be a processor in communication with the monitoring device, e.g., via a network, at a remote location. In addition to, or in lieu of sending an alert to a local and/or remote processor, in some instances, the monitoring device can be configured (e.g., via its own processor) to trigger a local visual or audible signal (e.g., a speaker, alarm, etc.) indicating to those individuals within a corresponding distance of the monitoring device that the threshold concentration has be exceeded. Once an alert has been sent, in some instances, the method 1600 at 1616 can reinitiate and begin another monitoring cycle. In such instances, the method 1600 can further monitor whether the concentration continues to exceed the threshold concentration or has decreased to below the threshold concentration.

The mass concentration also need not exceed the threshold concentration for the monitoring device to send data or other information to a local and/or remote processor. The monitoring device can be configured to send monitoring data continuously or periodically, such as for example, to monitor fluctuations in mass concentration of one or more particulates over a period of time and during certain activities.

In representative examples, the method 1600 can be performed over a measurement time. The measurement time can, for instance, be determined by a desired detection limit. As an example, a relatively greater measurement time can be used to achieve lower detection limits, i.e., monitor and record relatively low mass concentrations, while higher detection limits can be achieved over relatively lesser measurement times. To illustrate, Table 1 below lists examples of mass concentration (e.g., indicated by PM below and ρ above) detection limits for respirable crystalline silica over different measurement times, determined by relating the light absorption coefficient β_{abs} and MAE of silica to the measurement time in seconds. This can be expressed as:

$${PM}_{lower limit} [ \frac{μ g}{{m}^{3}} ] = \frac{NoiseEq {β}_{a b s} [ {Mm}^{- 1} ] measured each second}{M A E [ \frac{{m}^{2}}{gram} ] \sqrt{Measurement Time [ seconds ]}}$$

Where NoiseEq β_{abs} can be defined as the average of the light absorption measurement noise within the passband of the acoustic resonance, excluding the signal at resonance. This can be a helpful measure of the noise of the of the light absorption measurement. Each measurement can include both the light absorption signal at resonance and the average noise value.

As shown in Table 1, a measurement time of 1 sec. can result in a relatively high detection limit of approximately 120.0 μg/m³ when the MAE of silica is equal or approximately equal to 0.4 m²/g. In contrast, Table 1 shows a relatively low detection limit of 5.0 μg/m³ can be achieved with a relatively greater measurement time of 600 sec under the same conditions.

TABLE 1

| Measurement Time (seconds) | PM_{lower limit} (mg m⁻³) |
|---|---|
| 1 | 120 |
| 10 | 38 |
| 600 | 5 |

Given that the detection limit scales inversely with the power of the laser beam, each of these factors can be used to determine the measurement time based on a desired detection limit, or in the alternative, determine the detection limit based on the measurement time. As just one example, using the expression below and the expression above for the mass concentration, a relatively low detection limit of 0.5 μg/m³ can be achieved with a measurement time of 600 sec. and a measured laser beam power of 63 mW. Detection limits can thereby be improved by increasing the power of the laser beam.

$$NoiseEq {β}_{abs} [ {Mm}^{- 1} ] measured each second = 120 [ {Mm}^{- 1} ] \frac{6.3 [ mW ]}{Laser Power [ mW ]}$$

Accordingly, after the measurement time for monitoring has concluded, the method 1600 can be repeated in a similar manner for any number of cycles over any desired or predetermined period of time. In some examples, the method 1600 can be repeated or iterated continuously over the desired or predetermined time.

Although method 1600 is described as monitoring the mass concentration of silica, it should be appreciated that the method 1600 can be applied to monitoring silica, its various forms, and each of its possible interferents, and more broadly, a variety of particulate matter in various contexts. For instance, any particulate matter which absorbs light at the laser wavelength employed can be monitored.

### Calibration—Example

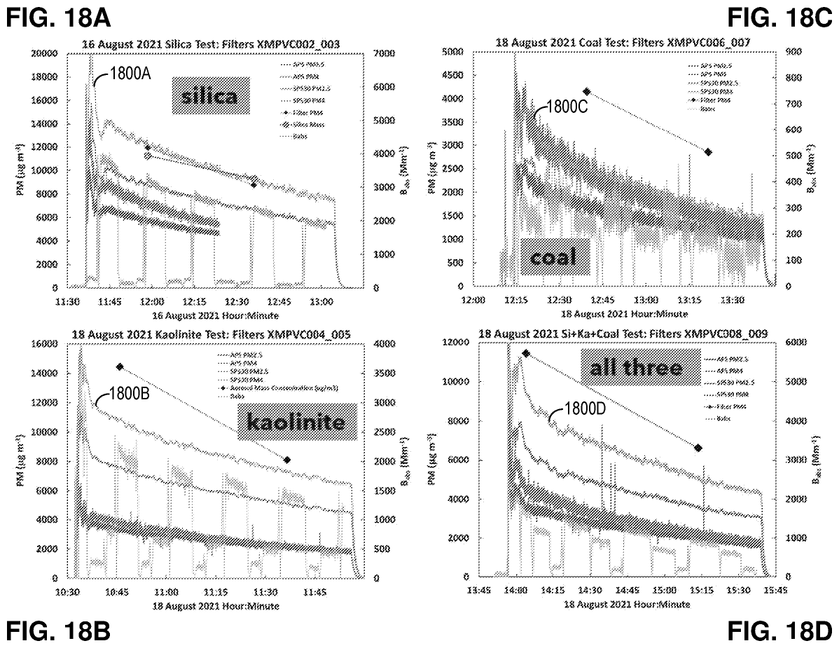

A monitoring device of the disclosed technology (e.g., monitoring devices 100, 1300) can be calibrated for particulate matter concentration measurements for arbitrary combinations of respirable dust particulates, including silica, kaolinite, coal dust, and/or other respirable particulates. Calibration can include first measuring a dispersed particulate of interest, such as silica, and its potential interferents kaolinite and coal dust. FIGS. 18A-18D, for example, show four times series measurements of dispersed silica dust, kaolinite dust, and coal dust individually (FIGS. 18A-18C) and in a dispersed mixture of all three particulates in equal volumes (FIG. 18D). The measured particulate mass concentrations PM are plotted on the left axes and the measured particulate light absorption coefficients β_{abs} are plotted on the right axes of FIGS. 18A-18D. The photoacoustic light absorption β_{abs} was measured at wavelengths λ₁=12.495 microns, λ₂=11.040 microns, and λ₃=11.826 microns for each of the times series measurements. These wavelengths correspond to the candidate wavelengths described herein, the respective wavelengths that silica, kaolinite, and coal dust strongly absorb light. Any number of wavelengths can also be used, including for other particulate matter, such as calcite which absorbs light strongly at a wavelength λ=11.4 microns. The relationship between the wavelength and strength of light absorption for silica, kaolinite, and coal dust is shown in the column matrix immediately below. Measurements of the mass concentration PM and light absorption coefficient β_{abs} measurements can be obtained via one or more non-real time techniques and in a controlled environment such that dust can be dispersed and measured. The measurements in FIGS. 18A-18D, for instance, were obtained in a laboratory setting via a Sensirion® SPS30 air quality sensor PM2.5 and PM4, TSI® Aerodynamic Particle Sizer (APS) 3321, and using various filter techniques, including by Fourier Transform Infrared Spectrometer (FTIR) measurements.

$$[ \begin{matrix}{λ}_{1} \\ {λ}_{2} \\ {λ}_{3}\end{matrix} ] = [ \begin{matrix}12.495 μm \\ 11.04 μm \\ 11.826 μm\end{matrix} ] = \begin{matrix}Strong Silica Light Absorption \\ Strong Kaolinite Light Absorption \\ Strong Coal Light Absorption\end{matrix}$$

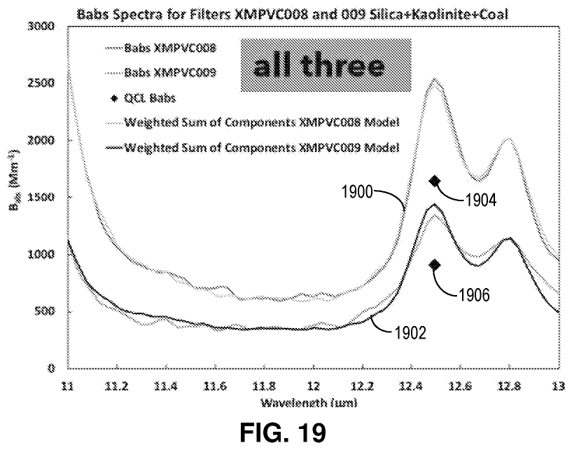

The mass concentrations PM and light absorption coefficient β_{abs} of one or more particulates and interferents can be related through a matrix of mass absorption efficiency values, MAE, values which can be determined from the time series measurements obtained and shown in FIGS. 18A-18C. This mathematical relationship between the MAE values, mass concentration PM, and light absorption coefficient β_{abs} is expressed below. To determine a MAE value, the ratio MAE=β_{abs}/PM can be used and determined from the axes of each of the time series measurements for each particulate and at each wavelength λ₁-λ₃. As one example, the MAEₛᵢ=β_{abs}/PM for silica dust particulates measured at the candidate wavelength λ₁=12.495 microns, can be obtained from the time series measurement axes scales of FIG. 19A, corresponding to the time around when the dust is first dispersed. The MAEₛᵢ ratio in this particular instance is equal to MAE=7,000 Mm⁻¹/20,000 μg/m³=0.350 m²g⁻¹, which corresponds to the measurements obtained via the SPS30 sensor and labeled 1800A-1800D in FIGS. 18A-18D. In the same or similar manner, the values for each MAE value within the respective matrix can be determined for each dust particulate type at each measured candidate wavelength using the time series measurements obtained. In this way, the measured light absorption coefficient β_{abs} values are related to the mass concentrations PM of the particulates through the matrix of MAE values, such as those shown below.

$$[ \begin{matrix}{β}_{a b s} ( {λ}_{1} ) \\ {β}_{a b s} ( {λ}_{2} ) \\ {β}_{a b s} ( {λ}_{3} )\end{matrix} ] = [ \begin{matrix}M A {E}_{s i} ( {λ}_{1} ) & M A {E}_{ka} ( {λ}_{1} ) & M A {E}_{co} ( {λ}_{1} ) \\ M A {E}_{s i} ( {λ}_{2} ) & M A {E}_{ka} ( {λ}_{2} ) & M A {E}_{co} ( {λ}_{2} ) \\ M A {E}_{s i} ( {λ}_{3} ) & M A {E}_{ka} ( {λ}_{3} ) & M A {E}_{co} ( {λ}_{3} )\end{matrix} ] [ \begin{matrix}{PM}_{si} \\ {PM}_{ka} \\ {PM}_{co}\end{matrix} ]$$

$$[ \begin{matrix}{β}_{a b s} & ( {λ}_{1} ) \\ {β}_{a b s} & ( {λ}_{2} ) \\ {β}_{a b s} & ( {λ}_{3} )\end{matrix} ] = [ \begin{matrix}0.30 & 0.100 & 0.16 \\ 0.015 & 0.275 & 0.16 \\ 0.02 & 0.038 & 0.14\end{matrix} ] [ \begin{matrix}{PM}_{si} \\ {PM}_{ka} \\ {PM}_{co}\end{matrix} ]$$

Using the above expression, the measured light absorption coefficient β_{abs} values can be converted into speciated mass concentrations of the dust particulates. Particularly, the matrix expression above can be inverted to give the mass concentrations PM measurements for silica PMₛᵢ, kaolinite PMₖₐ, and coal dust PM_{co} in terms of their light absorption measurements β_{abs}, which is shown below.

$$[ \begin{matrix}{PM}_{si} \\ {PM}_{ka} \\ {PM}_{co}\end{matrix} ] = [ \begin{matrix}3.039 & - 0.743 & - 2.62 \\ 0.103 & 4.293 & - 5.024 \\ - 0.462 & - 1.059 & 8.882\end{matrix} ] [ \begin{matrix}{β}_{a b s} ( {λ}_{1} ) \\ {β}_{a b s} ( {λ}_{2} ) \\ {β}_{a b s} ( {λ}_{3} )\end{matrix} ]$$

The diagonal MAE values of the resulting expression are positive (e.g., from the upper left corner to the lower right corner), indicating strong light absorption by the silica, kaolinite, and coal dust species at each of their respective strong light absorption wavelengths. The MAE values outside of the diagonal elements, are largely negative, indicating interference by the other species at each wavelength, such as by interferents kaolinite and coal dust in the case of silica. By relating the mass concentrations PM and light absorption coefficient β_{abs} through the matrix of MAE values in this way, a mass concentration PM can be determined for a desired particulate, which accounts for the light absorption by an interferent at or around the same wavelength. For example, as described herein, kaolinite acts as an interferent to silica due to kaolinite absorbing some degree of light at and around the wavelength silica strongly absorbs light (e.g., see FIG. 11). Since the above mathematical relationship for mass concentration PM accounts for the MAE values for both kaolinite and coal dust, the accuracy of the resulting mass concentration PM of silica is relatively improved due to the light absorption of the interferents being largely disregarded. The mass concentrations PM for kaolinite, coal dust, and/or any other respirable particulates can be calculated and benefit from improved accuracy in the same way.

To illustrate, the above expression relating the mass concentrations PM and light absorption coefficient β_{abs} can be used to confirm the mass concentration PM of all three particulates within the mixture shown in FIG. 18D, since the mass concentration (μg/m³) of each particulate can be known prior to the time series measurements. As shown below, the light absorption coefficient β_{abs} values for silica, kaolinite, and coal dust measured at each wavelength are 1107 Mm⁻¹, 729 Mm⁻¹, and 193 Mm⁻¹, respectively, while the mass concentrations PM are given in the far-left column. The mass concentrations PM of silicon and kaolinite are approximately equal, which is expected since they are equal in volume and of a similar density. Coal, having a density of approximately 1/2.6 of silica and kaolinite, does not disperse as well as the silica and kaolinite dust and therefore, relatively lower mass concentrations are expected. The sum of the mass concentrations PM is 5022 μg/m³, which is approximately the sum of the known volumes for the silica, kaolinite, and coal dust measured.

$$[ \begin{matrix}{PM}_{s i} = 2317 μg {m}^{- 3} \\ {PM}_{k a} = 2274 μg {m}^{- 3} \\ {PM}_{c o} = 431 μg {m}^{- 3}\end{matrix} ] = \text{} [ \begin{matrix}3.039 & - 0.743 & - 2.62 \\ 0.103 & 4.293 & - 5.024 \\ - 0.462 & - 1.059 & 8.882\end{matrix} ] [ \begin{matrix}{β}_{a b s} = 1107 {Mm}^{- 1} \\ {β}_{a b s} = 729 {Mm}^{- 1} \\ {β}_{a b s} = 193 {Mm}^{- 1}\end{matrix} ]$$

Accordingly, the instrumentation of the monitoring device of the disclosed technology (e.g., monitoring devices 100, 1300) can be calibrated to account for the interference caused by interferents while measuring the particulate matter of interest. For instance, a computing environment (e.g., computing environment 1700) communicatively coupled to the monitoring device can account for the MAE values of both the particulate matter being measured and its interferents using the MAE values measured during the above process. As such, when in operation and determining the mass concentration PM of a particulate matter of interest (e.g., silica), such as in implementing method 1600, the monitoring device can account for and disregard the light absorption β_{abs} of the interferents (e.g., kaolinite and coal dust) to provide a relatively improved mass concentration determination.

As one example, FIG. 19 shows the FTIR spectra from the measurement time series above in which a mixture of silica, kaolinite, and coal dust in equal volumes were measured (e.g., FIG. 18D). A measurement using the monitoring device of the disclosed technology was also obtained to measure the light absorption coefficient β_{abs} of silica at the wavelength λ₁=12.495 microns, the wavelength silica is known to strongly absorb light and experience interference from kaolinite and coal dust. As shown FIG. 19, the curves labeled 1900, 1902 reflect the linear superposition and additive effects of light absorption β_{abs} of all three particulates. In contrast, the measurements made by the monitoring device, labeled 1904, 1906, accounted for the light absorption β_{abs} of the kaolinite and coal dust as interferents and provided relatively greater accuracy with respect to the light absorption coefficient β_{abs} for silica, as the particulate matter of interest, and thereby can provide greater accuracy in determining the mass concentration PM of the silica.

### Computing Environment

FIG. 17 depicts a generalized example of a suitable computing system 1700 in which the described innovations can be implemented. The computing system 1700 is not intended to suggest any limitation as to scope of use or functionality, as the innovations may be implemented in diverse general-purpose or special-purpose computing systems.

With reference to FIG. 17, the computing system 1700 includes one or more processing units 1710, 1715 and memory 1720, 1725. In FIG. 17, this configuration 1730 is included within the dashed line. The processing units 1710, 1715 execute computer-readable instructions, such as for implementing the method of FIG. 16. A processing unit can be a general-purpose central processing unit (CPU), processor in an application-specific integrated circuit (ASIC) or any other type of processor. In a multi-processing system, multiple processing units execute computer executable instructions to increase processing power. For example, FIG. 17, shows a central processing unit 1710 as well as a graphics processing unit or co-processing unit 1715. The tangible memory 1720, 1725 may be volatile memory (e.g., registers, cache, RAM), non-volatile memory (e.g., ROM, EEPROM, flash memory, solid state drives, etc.), or combination of the two, accessible by the processing unit(s). The memory 1720, 1725 stores software 1780 implementing one or more innovations described herein, in the form of computer-executable instructions suitable for execution by the processing unit(s).

A computing system can have additional features. For example, the computing system 1700 includes storage 1740, one or more input devices 1750, one or more output devices 1760, and one or more communication connections 1770. An interconnection mechanism (not shown) such as a bus, controller, or network interconnects the components of the computing system 1700. Typically, operating system software (not shown) provides an operating environment for other software executing in the computing system 1700, and coordinates activities of the components of the computing system 1700.

The tangible storage 1740 may be removable or non-removable, and includes magnetic disks, magnetic tapes or cassettes, solid state drives, CD-ROMs, DVDs, or any other medium which can be used to store information in a non-transitory way and which can be accessed within the computing system 1700. The storage 1740 stores instructions for the software 1780 implementing one or more innovations described herein.

The input device(s) 1750 may be a touch input device such as a keyboard, mouse, pen, or trackball, a voice input device, a scanning device, or another device that provides input to the computing system 1700. The output device(s) 1760 may be a display, printer, speaker, CD-writer, or another device that provides output from the computing system 1700.

The communication connection(s) 1770 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations can be described in the general context of computer-executable instructions, such as those included in program modules, being executed in a computing system on a target real or virtual processor. Generally, program modules include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing system. Moreover, the disclosed technology can be implemented through a variety of computer system configurations, including personal computers, handheld devices, tablets, smart phones, headsets, multiprocessor systems, microprocessor systems, microprocessor-based or programmable consumer electronics, network PCs, minicomputers, mainframe computers, and the like.

### General Considerations

As used in this application and in the claims, the singular forms “a,” “an,” and “the” include the plural forms unless the context clearly dictates otherwise. Additionally, the term “includes” means “comprises.” Further, the term “coupled” does not exclude the presence of intermediate elements between the coupled items.

The systems, apparatus, and methods described herein should not be construed as limiting in any way. Instead, the present disclosure is directed toward all novel and non-obvious features and aspects of the various disclosed embodiments, alone and in various combinations and sub-combinations with one another. The disclosed systems, methods, and apparatus are not limited to any specific aspect or feature or combinations thereof, nor do the disclosed systems, methods, and apparatus require that any one or more specific advantages be present or problems be solved. Any theories of operation are to facilitate explanation, but the disclosed systems, methods, and apparatus are not limited to such theories of operation.

Although the operations of some of the disclosed methods are described in a particular, sequential order for convenient presentation, it should be understood that this manner of description encompasses rearrangement, unless a particular ordering is required by specific language set forth. For example, operations described sequentially may in some cases be rearranged or performed concurrently. Moreover, for the sake of simplicity, the attached figures may not show the various ways in which the disclosed systems, methods, and apparatus can be used in conjunction with other systems, methods, and apparatus. Additionally, the description sometimes uses terms like “produce” and “provide” to describe the disclosed methods. These terms are high-level abstractions of the actual operations that are performed. The actual operations that correspond to these terms will vary depending on the particular implementation and are readily discernible by one of ordinary skill in the art.

In some examples, values, procedures, or apparatus are referred to as “lowest”, “best”, “minimum,” or the like. It will be appreciated that such descriptions are intended to indicate that a selection among many used functional alternatives can be made, and such selections need not be better, smaller, or otherwise preferable to other selections.

Examples are described with reference to directions indicated as “above,” “below,” “upper,” “lower,” and the like. These terms are used for convenient description, but do not imply any particular spatial orientation. As used herein, thermal contact does not require a direct physical contact but only a thermally conductive path.

In view of the many possible embodiments to which the principles of the disclosed technology may be applied, it should be recognized that the illustrated embodiments are only examples and should not be taken as limiting the scope of the disclosure. We therefore claim all that comes within the scope and spirit of the appended claims.

1. A monitoring device comprising:
a resonator comprising an inlet, an outlet, a chamber extending between the inlet and the outlet, and a resonant frequency;
a pump mechanism configured to draw in and direct an airborne particulate surrounding the monitoring device into the inlet and through the chamber and outlet of the resonator;
an optical source situated and configured to provide and direct a laser beam into the chamber of the resonator at a predetermined modulation frequency, wherein the airborne particulate within the resonator absorbs energy from the laser beam and transmits heat into the surrounding air;
a photodetector situated and configured to receive and measure a power of the laser beam leaving the resonator; and
a sensor situated and configured to measure a sound pressure within the chamber of the resonator associated with the heat transmitted from the airborne particulate.

2. The monitoring device of claim 1, further comprising a processor including computer-readable instructions, wherein by executing the instructions, the processor is configured to:
determine a mass concentration of the airborne particulate based on a ratio of the measured sound pressure of the resonator and power of the laser beam.

3. The monitoring device of claim 2, wherein the processor is further configured to:
determine whether the mass concentration of the airborne particulate exceeds a threshold concentration; and
upon determining the mass concentration exceeds the threshold concentration, send an alert to one or more local and/or remote processors communicatively coupled to the processor of the monitoring device, wherein the alert indicates the mass concentration of the airborne particulate exceeds the threshold concentration.

4. The monitoring device of claim 2, wherein the processor is further configured to:
communicate the mass concentration of the airborne particulate in real time to one or more local and/or remote processors communicatively coupled to the processor.

5. The monitoring device of claim 1, wherein the optical source is a quantum cascade laser.

6. The monitoring device of claim 1, wherein the resonant frequency of the resonator ranges from 0 Hz to 2000 Hz.

7. The monitoring device of claim 1, wherein a wavelength of the laser beam ranges from 11 microns to 13 microns.

8. The monitoring device of claim 1, wherein the predetermined modulation frequency of the laser beam is equal to the resonant frequency of the resonator.

9. The monitoring device of claim 1, wherein the laser beam is modulated with a square wave at the predetermined modulation frequency.

10. The monitoring device of claim 1, further comprising at least one acoustic filter situated and configured to filter sound external to the resonator chamber.

11. The monitoring device of claim 1, wherein the photodetector is a mercury-cadmium-telluride (MCT) detector.

12. The monitoring device of claim 1, wherein an amplifier is coupled to the photodetector to amplify a signal output of the photodetector associated with the power of the laser beam.

13. The monitoring device of claim 1, wherein the optical source comprises one or more lasers.

14. The monitoring device of claim 1, wherein the sensor is a microphone or a cantilever sensor.

15. A method comprising:
drawing in a particulate species through an inlet and into a chamber of a resonator of a monitoring device;
directing a laser beam into the chamber of the resonator and toward the particulate species such that the particulate species absorbs energy from the laser beam and transmits heat to the surrounding air within the chamber of the resonator;
measuring a power of the laser beam as it leaves the resonator and a sound pressure within the chamber of the resonator associated with the transmission of heat by the particulate species; and
determining a mass concentration of the particulate species based on a ratio of the measured sound pressure and power of the laser beam.

16. The method of claim 15, further comprising modulating a power of the laser beam to correspond with a resonant frequency of the resonator.

17. The method of claim 15, further comprising determining whether the mass concentration of the particulate species exceeds a threshold concentration.

18. The method of claim 17, wherein upon determining the mass concentration exceeds the threshold concentration, the method further comprises:
sending an alert to one or more local and/or remote processors indicating the mass concentration of the particulate species exceeds the threshold concentration.

19. (canceled)

20. The method of claim 17, wherein upon determining the mass concentration exceeds the threshold concentration, the method further comprises:
triggering a local signal of the monitoring device to indicate the mass concentration of the particulate species exceeds the threshold concentration.

21-27. (canceled)

28. A device for monitoring a mass concentration of silica particulates comprising:
a resonator comprising an inlet, an outlet, a chamber extending between the inlet and the outlet, and a resonant frequency;
a pump mechanism configured to draw in and direct silica particulates surrounding the monitoring device into the inlet and through the chamber and outlet of the resonator;
a quantum cascade laser situated and configured to provide and direct a laser beam modulated with a square wave into the chamber of the resonator at a laser power modulation frequency approximately equal to the resonant frequency of the resonator, wherein the silica particulates within the resonator absorbs energy from the laser beam and transmits heat into the surrounding air within the chamber of the resonator;
a photodetector situated and configured to receive and measure a power of the laser beam leaving the resonator; and
a sensor situated and configured to measure a sound pressure within the chamber of the resonator associated with the heat transmitted from the silica particulates,
wherein a wavelength of the laser beam ranges from 11 microns to 13 microns.
